(19) United States
(12) Patent Application Publication
(10) Pub. No.: US 2026/0202637 A1
(43) Pub. Date: Jul. 16, 2026

(54) SYSTEM AND METHOD OF MAPPING A DUCT

(71) Applicant: Condux International, Inc., Mankato, MN (US)

(72) Inventors: Bradley P. Radichel, Edina, MN (US); Joshua J. Siebert, Lake Crystal, MN (US); David J. Stockton, Woodbrige (GB); Eric L. Cope, Mankato, MN (US)

(73) Assignee: Condux International, Inc., Mankato, MN (US)

(21) Appl. No.: 19/561,244

(22) Filed: Mar. 9, 2026

Related U.S. Application Data
(63) Continuation of application No. 17/575,441, filed on Jan. 13, 2022, now Pat. No. 12,591,101.
Application No. 17/575,441 is a continuation of application No. 15/570,597, filed on Apr. 28, 2016, now Pat. No. 11,255,479.
(60) Provisional application No. 62/154,470, filed on Apr. 29, 2015.

(51) Int. Cl. G02B 6/50; F16L 55/48; F16L 101/30; G02B 6/52

(52) U.S. Cl. CPC G02B 6/50; F16L 55/48; F16L 2101/30; G02B 6/52

(57) ABSTRACT

A unit that houses tracking electronics configured to be passed through a duct while the tracking electronics collect position information is provided. The information collected by the unit is used to map the duct. A method of mapping a duct is also provided.

### CROSS-REFERENCE TO RELATED APPLICATIONS

This application is a Continuation of U.S. application Ser. No. 17/575,441, filed on Jan. 13, 2022, which is a Continuation of U.S. application Ser. No. 15/570,597, U.S. Pat. No. 11,255,479, filed on Oct. 30, 2017, which is a U.S. National Stage application of PCT International Patent Application No. PCT/US2016/029816, filed on Apr. 28, 2016, which claims priority to U.S. Provisional Patent Application No. 62/154,470 , filed on Apr. 29, 2015, the disclosures of which are hereby incorporated by reference in their entireties. To the extent appropriate a claim of priority is made to each of the above-disclosed applications.

### TECHNICAL FIELD

A system and method for mapping a duct involving blowing a data recording unit through a duct and collecting data from the unit to map the duct.

### BACKGROUND

Ducts, conduits and pipes, which are terms used herein interchangeably, are often preinstalled in areas that are difficult to access (underground, crawl spaces, in walls, etc.). It is often desirable to know the path of the ducts including the length of the ducts, what bends exist, and the degree and direction of each of the bends. This is because the length and complexity of the route (bends and inclines) affects the distance that a cable can be installed into that duct. This is the case irrespective of whether the cable is to be installed by any of the well-known techniques including fluid propulsion (gas or liquid), pushing or pulling. In the situation described below, the common technique of air-blowing is referred to but the principles can be extended to the other techniques listed above.

For example, prior to installing fiber optic cables into a duct, it is desirable to map the duct to determine how best to install the cable. If the duct is generally straight, it may be possible to install the fiber optic cable all in one shot. However, if the duct takes a twisted path, it might need to be installed in two or more blowing steps. Without the benefit of duct mapping the fiber optic cable installer would need to guess at the best location from which to blow the cable and guess how many steps may be required. If the operator over-estimates the ability to blow the cable, the cable can become stuck at an inconvenient location (e.g., in a duct buried in a cement wall, in a duct deep under a road) requiring retracting the cable and reinstalling it from another location, or worse excavating at the inconvenient location to free the cable. This trial and error process is time consuming and inefficient. On the other hand, if the operator underestimates the ability to blow the cable and chooses to blow the cable in multiple stages, this may also be inefficient. In situations where the duct is generally level and straight with only gradual curves, it may be possible to install the cable in fewer steps than would be expected. Accordingly, accurate mapping of the duct can improve the installation of cable within the duct. Many other advantages of duct mapping exist for example the possibility to overlay the recorded data onto a Graphical Interface System (GIS) to provide a real world (‘as built’) record of the cable and duct deployment. In addition it may be possible to download the routing information onto an electronic interface for controlling the installation process.

### SUMMARY

The present disclosure provides a unit that contains tracking electronics. The unit is configured to be passed through the duct while the tracking electronics collects position information. The information collected by the unit can be used to map the duct. A method of mapping a duct is also provided.

### BRIEF DESCRIPTION OF THE DRAWINGS

FIG. 1 is a side elevation view of a unit according to the present disclosure in a straight duct; and

FIG. 2 is a side elevation view of the unit of FIG. 1 in a curved duct.

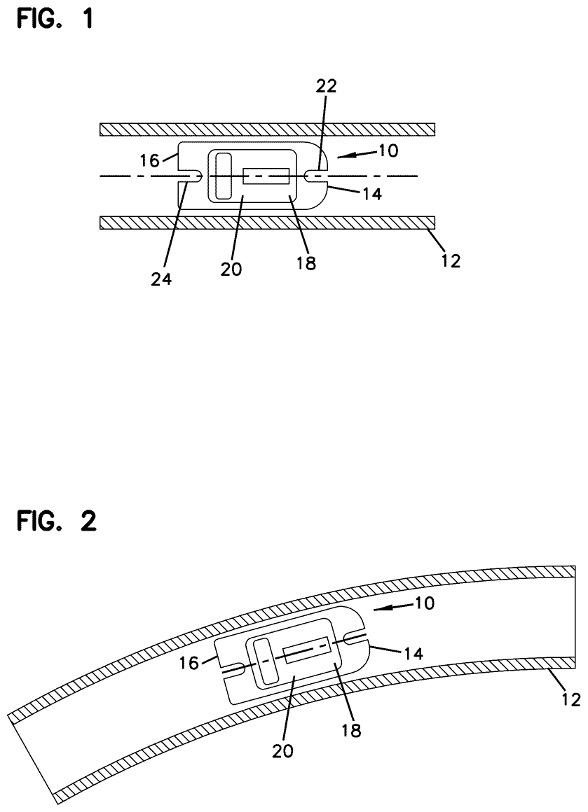

### DETAILED DESCRIPTION

Referring to the FIGS., systems for mapping a duct according to the present disclosure are described herein in further detail. In the depicted embodiment the system includes a unit 10 configured to be passed through a duct 12. The unit 10 includes a body portion having a first end portion 14 and a second end portion 16. The body portion defines an internal cavity 18 configured to house electrical components 20 therein. In the depicted embodiment, the first end portion 14 includes a rounded leading surface and the second end portion 16 defines a trailing surface. A device configured to drive the unit 10 through a duct 12, for example, a blower. The system can also include a processor configured to receive information collected by the unit 10 as the unit travels through the duct 12 to map the duct 12.

In the depicted embodiment, the electrical components include a battery, a six degree of freedom microprocessor chip, as well as memory and communication electronics. The 6 degree of freedom feature is useful in that it provides 3-axis acceleration, 3-axis angular rate and brain functions. In the depicted embodiment, the electrical components are connected together to form a modular electrical unit. The modular electrical unit is configured to be removed from one unit and placed into another unit. The system can include multiple units of various sizes, each of the units configured to receive the modular electrical unit. The selection of the proper unit for a particular application can depend on the type and size of the duct. It should be appreciated that many other types of electrical components can be carried by the unit. For example, the electrical components could also include a toxic material sensor, magnetic field detector, pressure sensor, moisture sensor, or infrared scanner.

As discussed above, the unit 10 is configured to collect position data as it moves through the duct. In some embodiments the unit 10 is configured to transmit data so that it can be tracked as it moves through the duct. In addition to collecting position data, unit 10 can be configured to clean the duct as it moves through the duct 12, or alternatively to transfer lubricant to the duct surface. In the depicted embodiment, the unit 10 is configured to be connected with other units. The each units can be configured for their own functions (e.g., one unit could be for cleaning, another for detecting moisture, another for tracking position). In the depicted embodiment, the first end portion 14 includes a pulling eye 22 configured to connect to a duct pull cord and/or to connect to another unit, and the second end portion 16 includes an inboard link 24 configured to connect to another unit. In the depicted embodiment, the unit has an overall length of less than ten millimeters, which enables the unit to move efficiently through ducts with bends. For example, a unit having an outer diameter of between four and five millimeters (about 4.5 mm) can be blown through a 5.5 mm inner diameter duct with a minimum bend radius of 70 mm.

In the depicted embodiment, the system can further include a display configured to visually display the duct configuration. The unit can also include a system that provides detailed data that can be imported into blowing performance software to provide recommended flow rate, blowing pressure, and locations for blowing for example. In the depicted embodiment, the system also includes a unit trap configured to be mounted to a far end of the duct to trap the unit as it exits the duct. It should be appreciated that the system can include fewer features or more features than are described herein.

The present disclosure also provides a method for mapping a duct including selecting a unit that has a diameter that is within 5-25 percent smaller than the diameter of a duct of which the unit is configured to be blown through; inserting a modular electrical unit into the selected unit, the modular electrical unit configured to track the position of the unit; blowing the unit through the duct while the modular electrical unit collects and stores data regarding the position of the unit; and mapping the duct based on the data collected by the unit.

The method can also include providing recommended flow rate, blowing pressure, and locations for blowing based on information collected by the unit and received by the processor. In addition it can also include providing information to another software application that visually displays the mapped route.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A system for mapping a duct comprising:
a unit configured to be passed through a duct, the unit including a body portion having a first end portion and a second end portion, wherein the body portion defines an internal cavity configured to house electrical components therein;
a device configured to drive the unit through a duct; and
a processor configured to receive information collected by the unit as it travels through the duct to map the duct.

2. The system of claim 1 where wherein the first end portion includes a rounded leading surface, wherein the second end portion defines a trailing surface.

3. The system of claims 1-2, wherein the electrical components include a battery.

4. The system of claims 1-3, wherein the electrical components include a six degree of freedom microprocessor chip.

5. The system of claims 1-4, wherein the electrical components include memory and communication electronic.

6. The system of claims 1-5, wherein the electrical components are connected together to form a modular electrical unit and configured to be removed from one unit and placed into another unit.

7. The system of claims 1-6, further comprising multiple units of various sizes, each of the units configured to receive the modular electrical unit.

8. The system of claims 1-7, wherein the electrical components are selected from the group consisting of a toxic material sensor, magnetic field detection, pressure sensor, moisture sensor, and infrared scanner.

9. The system of claims 1-8, further comprising a display configured to visually display the duct configuration.

10. The system of claims 1-9, wherein that the processor is configured provide recommended flow rate, blowing pressure, and locations for blowing based on the received information.

11. The system of claims 1-10, wherein the unit is configured to transmit data so that it can be tracked as it moves through the duct.

12. The system of claims 1-11, wherein the first end portion includes a pulling eye configured to connect to another unit.

13. The system of claims 1-12, wherein the second end portion includes an inboard link configured to connect to another unit.

14. The system of claims 1-13, wherein the unit has an overall length of less than ten millimeters.

15. The method of claims 1-14, wherein the unit has an outer diameter of between four and five millimeters.

16. The system of claims 1-15, further comprising a unit trap configured to be mounted to a far end of the duct to trap the unit as it exits the duct.

17. The system of claims 1-16, wherein the unit is configured to clean and/or lubricate the duct as it moves through the duct.

18. The system of claims 1-17, wherein the unit can also include a system that provides detailed data that can be imported into blowing performance software to provide recommended flow rate, blowing pressure, and locations for blowing.

19. A method for mapping a duct comprising:
selecting a unit that has a diameter that is within 5-25 percent smaller than the diameter of a duct of which the unit is configured to be blown through;
inserting a modular electrical unit into the selected unit, the modular electrical unit configured to track the position of the unit;
passing the unit through the duct while the modular electrical unit collects and stores data regarding the position of the unit; and
mapping the duct based on the data collected by the unit.

20. The method of claim 19, further comprising visually displaying the layout of the duct.

21. The method of claim 19, further comprising providing the operator recommendations for installing a cable into the duct, based at least in part on the mapped layout of the duct.

22. A method according to claims 19-21, using the system of claims 1-18.
